(19) United States
(12) Patent Application Publication
(10) Pub. No.: US 2007/0231057 A1
(43) Pub. Date: Oct. 4, 2007

(54) LOOSE-LEAF RING

(75) Inventor: Hung Yu Cheng, Hong Kong (CN)

Correspondence Address: MARSHALL, GERSTEIN & BORUN LLP, 233 S. WACKER DRIVE, SUITE 6300, SEARS TOWER, CHICAGO, IL, 60606, US

(73) Assignee: LECO STATIONERY MANUFACTURING COMPANY LIMITED

(21) Appl. No.: 11/689,800

(22) Filed: Mar. 22, 2007

(30) Foreign Application Priority Data
Mar. 29, 2006 (CN) CN 200610071656.8

(51) Int. Cl. B42F 13/02

(52) U.S. Cl. 402/20

(57) ABSTRACT

The invention relates to a loose-leaf ring for retaining loose-leaf pages comprising: two half ring members for retaining loose-leaf pages; and a resilient connector for movably connecting two half ring members. The loose-leaf ring according to the invention is easy to open and close and is not likely to deform, and allows loose-leaf pages retained by it to be turned easily.

### FIELD OF THE INVENTION

This invention relates on a loose-leaf ring for retaining loose-leaf pages.

### BACKGROUND OF THE INVENTION

In addition to a ring binder mechanism for retaining loose-leaf pages such as hole-punched papers, a loose-leaf ring is generally used to retain loose-leaf pages, thereby saving the cost. A well-known loose-leaf ring generally comprises two half ring members. Two half ring members interconnect with each other at one end by means of a connector such as a pin, allowing them to pivot on the pin in a predetermined range to open or close two half ring members. Two half ring members are provided at the other end with hook-like portions opposite laterally to each other. Two half ring members lock together by engaging the laterally opposite hook-like portions with each other.

A disadvantage of such a well-known loose-leaf ring is that, when it is necessary to open the loose-leaf ring, the laterally opposite hook-like portions of two half ring members must be forcedly pulled outwards apart to displace them. Then, two half ring members are pulled manually to pivot them away from each other on the pin, thereby opening the loose-leaf ring. The above operation is relatively inconvenient, and two half ring members may deform and thus impossible to lock reliably them together with increasing numbers of opening and closing.

Another disadvantage of this well-known loose-leaf ring is that, since two half ring members overlap with each other at the position of interconnecting two half ring members by means of the pin, the size of the loose-leaf ring at this position becomes substantially larger. When loose-leaf pages are turned along the loose-leaf ring, they may be blocked and even torn up.

Accordingly, there is need for an improved loose-leaf ring.

### SUMMARY OF THE INVENTION

An object of the invention is to provide a loose-leaf ring, which is convenient to operate and may avoid from tearing up the loose-leaf pages.

According to the invention, a loose-leaf ring for retaining loose-leaf pages comprises:

two half ring members for retaining loose-leaf pages; and

a resilient connector for movably connecting two half ring members.

The loose-leaf ring according to the invention is very convenient to operate since the loose-leaf ring may be opened only by pulling two half ring members apart in the opposite directions without forcedly pulling two half ring members outwards to displace them. Even after used for a long time, two half ring members are not easy to deform and can be locked reliably together. The size at the connection position of two half ring members decreases considerably and the connection position becomes generally smooth by connecting two half ring members together with the resilient connector. Thus, loose-leaf pages can be turned smoothly along retained the loose-leaf ring without tearing loose-leaf pages up.

The loose-leaf ring according to the invention is easy to open and close and is not likely to deform, and allows loose-leaf pages retained by it to be turned easily.

Other features of the invention will be in part apparent and in part pointed out hereinafter.

### BRIEF DESCRIPTION OF THE DRAWINGS

FIG. 1 is a front view of a loose-leaf ring according to the invention;

FIG. 2 is a side view of a loose-leaf ring according to the invention;

FIG. 3 is a top view of a loose-leaf ring according to the invention;

FIG. 4 is a bottom view of a loose-leaf ring according to the invention;

FIG. 5 is a perspective view of a loose-leaf ring according to the invention;

FIG. 6 is an exploded perspective view of a loose-leaf ring according to the invention;

FIG. 7 is a perspective view of a loose-leaf ring according to the invention, showing the loose-leaf ring at an open state; and

FIG. 8 is a front view of a loose-leaf ring according to the invention, showing the loose-leaf ring at an open state.

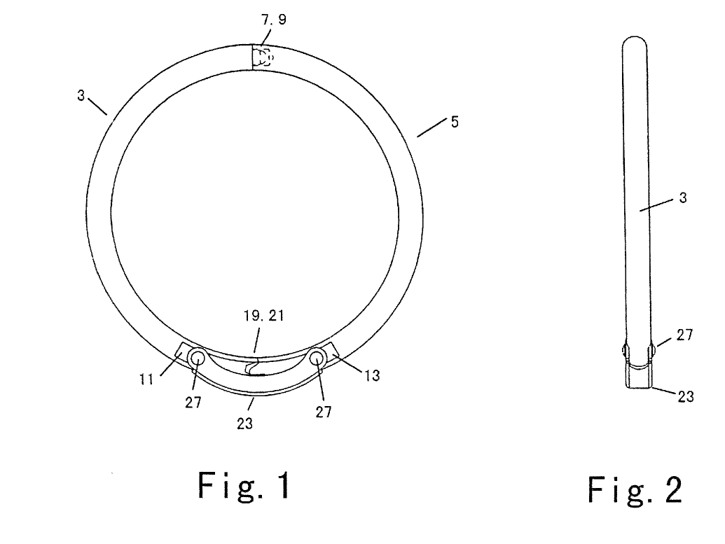

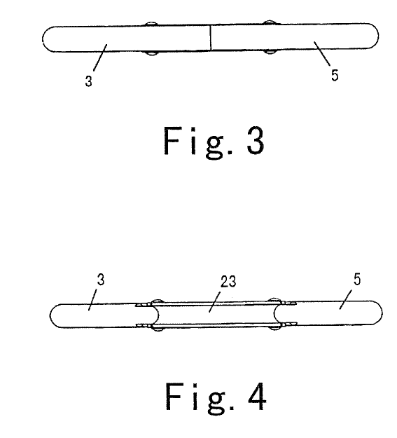

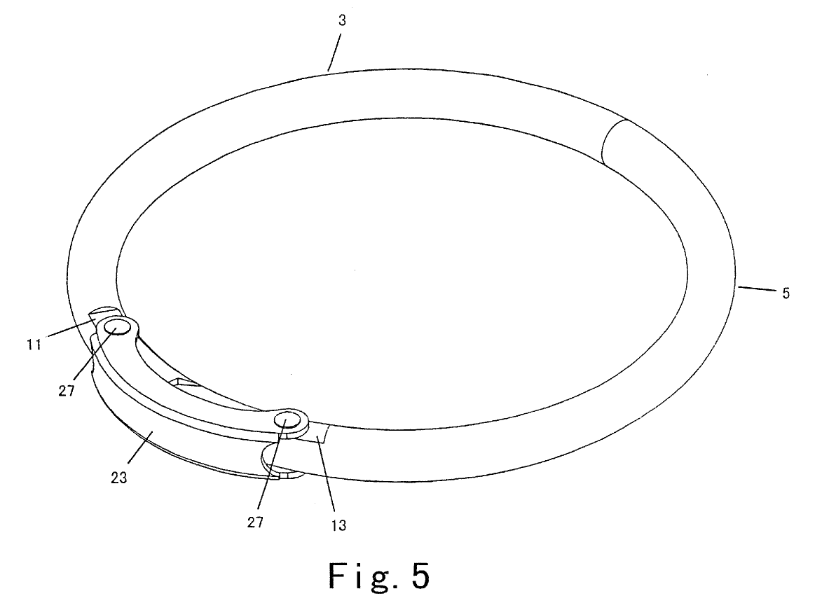

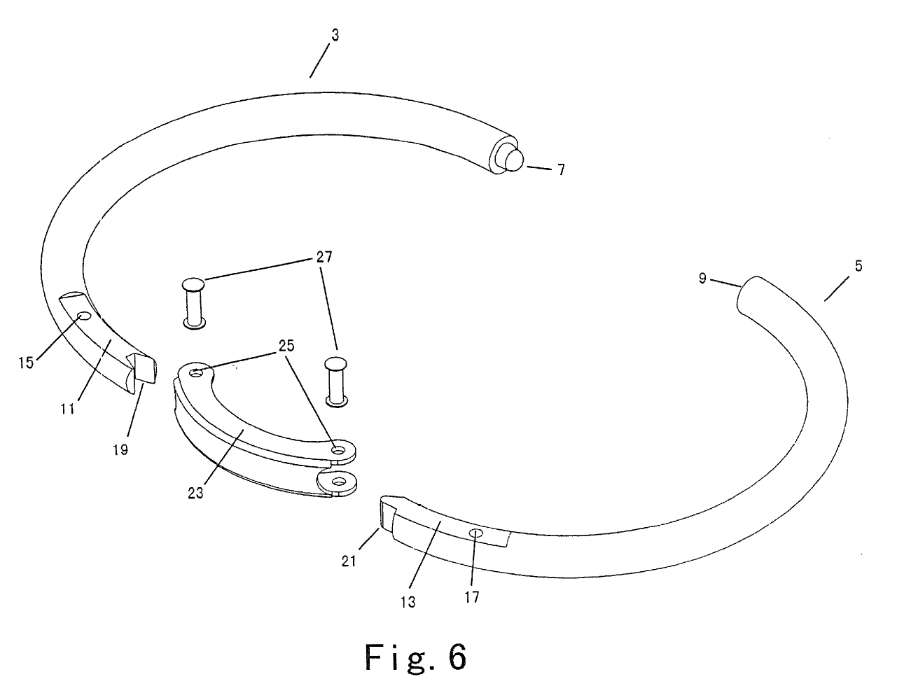

### DETAILED DESCRIPTION OF THE PREFERRED EMBODIMENTS

A loose-leaf ring 1 according to the invention will be described in detail with reference to the accompanying drawings. The loose-leaf ring 1 of the invention comprises two half ring members 3 and 5. The cross section of two half ring members 3 and 5 shown in the drawings is circular. Alternatively, their cross section may be semicircular, elliptical or rectangle. Two half ring members 3 and 5 themselves have a semicircular shape respectively. However, as known, two half ring members 3 and 5 may have other shape. For example, one has a semicircular shape and the other has generally a “]” shape, thereby forming substantially a D-shaped ring when they close. The free ends of two half ring members 3 and 5 are provided respectively with engaging portions 7 and 9 for engaging with each other, in order to prevent two half ring members at the close state from disengaging accidentally from each other. The engagement portions 7 and 9 shown in the drawings are one cylindrical protrusion formed on the half ring member 3 and one cylindrical depression formed on the half ring member 5 to engage with the cylindrical protrusion. Of course, a cylindrical depression may be formed on the half ring member 3 and a cylindrical protrusion may be formed on the half ring part 5. As known by those skilled in the art, the shape of the protrusion and the depression is not limited to be cylindrical. For example, their shape may be semicircular, conical, I-shaped, cross-shaped or V shaped, etc.

Two outward and opposite sides of the other ends of two half ring members 3 and 5 are recessed to form flat portions 11 and 13 respectively, thereby further decreasing the size of the connection position when assembled. The flat portions 11 and 13 at only one side of the other ends are shown in the drawings and the flat portions at the opposite side are invisible. It should be understood that it is preferable to form the flat portions recessed at each of the other ends, and that it is also feasible to form no flat portions. A projecting portion 21 and a recessed portion 19 engagable loosely with each other are formed at the other ends of two half ring members 3 and 5 respectively such that the projecting portion 21 and the recessed portion 19 may move slightly relative to each other after assembled. Preferably, two side surfaces of the recessed portion 19 are splayed slightly outwards to facilitate the relative movement between the projecting portion 21 and the recessed portion 19. The cross section shape of the projecting portion 21 and the recessed portion 19 may be rectangle, trapezoid, V-shaped or any other suitable shape. As shown in the drawings, the projecting portion 21 is formed on the half ring member 5 and the recessed portion 19 on the half ring member 3. Of course, it is also feasible that the projecting portion 21 is formed on the half ring member 3 and the recessed portion 19 on the half ring member 5. It is also feasible that the projecting portion and the recessed portion are not formed on the other ends of two half ring members 3 and 5. Two through holes 15 and 17 are formed respectively at a position distant from the tip of the other ends.

The loose-leaf ring 1 according to the present invention further comprises a resilient connector 23 for movably connecting two half ring members 3 and 5 together. As shown in the drawings, the resilient connector 23 has an arc shape whose cross section is generally U-shaped, and has through holes 25 formed at its two ends respectively. However, the resilient connector 23 may be formed of one or two arc-shaped resilient sheets or resilient wires. In the case that there is only one arc-shaped resilient sheet or resilient wire, it is mounted to one side of two half ring members 3 and 5. In the case that there are two arc-shaped resilient sheets or resilient wires, they are mounted to two sides of two half ring members 3 and 5. The resilient connector with a linear shape also falls within the scope of the invention.

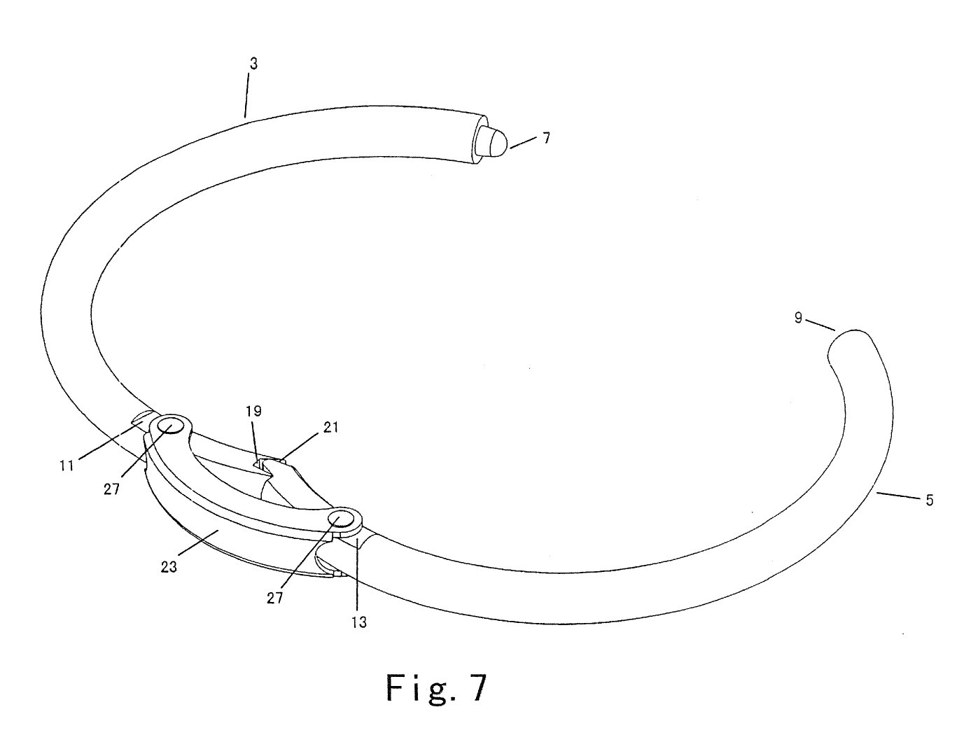

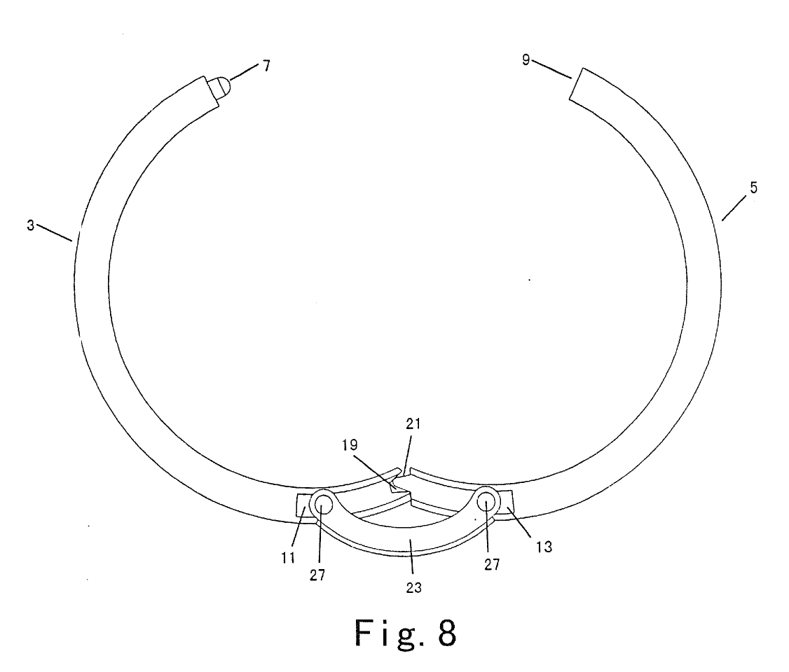

Two half ring members 3 and 5 and the resilient connector 23 may be assembled to form a complete loose-leaf ring 1 by simply passing the pins 27 through the through holes 15 and 17 of two half ring members 3 and 5 and the through holes 25 of the resilient connector 23. In use, two half ring members 3 and 5 are pulled in opposite directions against the resilience of the resilient connector 23 to open two half ring members 3 and 5, as shown in FIGS. 7 and 8. Since the projecting portion 21 and the recessed portion 19 are formed respectively at the other ends of two half ring members 3 and 5, one sidewall of the recessed portion 19 abuts against the projecting portion 21 at the open state such that the loose-leaf ring 1 is stable at the open state for adding or removing loose-leaf pages. In the open state, by pushing two half ring members 3 and 5 in directions facing to each other and by means of resiliently restoring of the resilient connector 23, two half ring members 3 and 5 move into the close state under interaction of the projecting portion 21 and the recessed portion 19. The resilient connector 23 also keeps two half ring members 3 and 5 at the close state.

The loose-leaf ring according to the invention is very convenient to operate since the loose-leaf ring may be opened only by pulling two half ring members apart in the opposite directions without forcedly pulling two half ring members outwards to displace them. Even after used for a long time, two half ring members are not easy to deform and can be locked reliably together. The size at the connection position of two half ring members decreases considerably and the connection position becomes generally smooth by connecting two half ring members together with the resilient connector which generally matches to the shape of two half ring members. Thus, loose-leaf pages can be turned smoothly along retained the loose-leaf ring without tearing loose-leaf pages up.

The elements of the loose-leaf ring according to the embodiment described and illustrated herein is made preferably from a suitable rigid material such as metals (e.g., steel). However, the loose-leaf ring made from non-metallic material, especially from plastics, also falls within the scope of the invention.

As various changes could be made in the above without departing from the scope of the invention, it is intended that all matter contained in the above description and shown in the accompanying drawings shall be interpreted as illustrative and not in a limiting sense.

1. A loose-leaf ring for retaining loose-leaf pages comprising: two half ring members for retaining loose-leaf pages; and
a resilient connector for movably connecting two half ring members.

2. The loose-leaf ring of claim 1, wherein the resilient connector has an arc shape whose cross section is U-shaped, such that the resilient connector connects matchingly two half ring members.

3. The loose-leaf ring of claim 1, wherein the resilient connector is formed of one or two arc-shaped resilient sheets such that the resilient connector connects matchingly two half ring members.

4. The loose-leaf ring of claim 1, wherein the resilient connector has a linear shape.

5. The loose-leaf ring of claim 1, wherein the ends of two half ring members connected by the resilient connector are provided respectively with a projecting portion and a recessed portion engagable loosely with each other.

6. The loose-leaf ring of claim 5, wherein two side surfaces of the recessed portion are splayed outwards.

7. The loose-leaf ring of claim 5, wherein the cross section of the projecting portion and the recessed portion is one of rectangular, trapezoidal, or V-shaped.

8. The loose-leaf ring of claim 1, wherein at least one of two outward and opposite sides of the ends of two half ring members connected by the resilient connector is recessed to form a flat portion.

9. The loose-leaf ring of claim 1, wherein the free ends of two half ring members are provided respectively with the engaging portions for engaging with each other to prevent two half ring members at the close state from disengaging accidentally from each other.

10. The loose-leaf ring of claim 9, wherein the engagement portions are one protrusion on one half ring member and one depression for engaging with the protrusion on the other half ring member.

11. The loose-leaf ring of claim 10, wherein the protrusion and the depression are one of cylindrical, semicylindrical, conical, I-shaped, cross-shaped or V-shaped.

12. The loose-leaf ring of claim 1, wherein the shape of two half ring members is semicircular; or the shape of one half ring member is semicircular and the shape of the other half ring member is “]”-shaped.

13. The loose-leaf ring of claim 1, wherein the cross section of two half ring members is one of circular, semicircular, elliptical or rectangular.

14. The loose-leaf ring of claim 1, wherein the resilient connector is formed of one or two arc-shaped resilient wires such that the resilient connector connects matchingly two half ring members.
